(19) United States
(12) Patent Application Publication
(10) Pub. No.: US 2019/0017441 A1
(43) Pub. Date: Jan. 17, 2019

(54) GAS TURBINE ENGINE COMBUSTOR

(71) Applicant: General Electric Company, Schenectady, NY (US)

(72) Inventors: Krishnakumar Venkatesan, Niskayuna, NY (US); Narendra Digamber Joshi, Niskayuna, NY (US)

(21) Appl. No.: 15/651,088

(22) Filed: Jul. 17, 2017

(51) Int. Cl. F02C 7/262; F23R 3/00; F02D 37/02

(52) U.S. Cl. CPC F02C 7/262; F02D 37/02; F23R 3/002

(57) ABSTRACT

A gas turbine engine combustor includes a dome plate, an inner liner, and an outer liner. The inner liner and the outer liner are separately coupled to a rear side of the dome plate and both extend rearward therefrom. The outer and inner liners define an annular combustion chamber therebetween that extends rearward from the dome plate. At least one of the outer liner or the dome plate includes an igniter cavity formed therein that is separated from the combustion chamber by a partition wall. The partition wall defines one or more transfer holes therethrough that fluidly connect the igniter cavity to the combustion chamber.

### FIELD

The subject matter described herein relates to combustors in gas turbine engines.

### BACKGROUND

Smaller gas turbine combustors can operate at higher compression ratios (or operating pressure ratios) than larger combustors. Smaller combustors can reduce the weight of the combustor and reduce emissions generated by the engines (e.g., nitrogen oxide emissions). One significant disadvantage of reduced-volume combustors, however, is inhibited re-ignition at high altitude after experiencing a flameout.

A flameout occurs when the combustion reaction within the combustor is unintentionally or unexpectedly extinguished during operation of the gas turbine engine. The flameout can be caused by various factors, including pressure variations, a stall in the compressor, insufficient oxygen in the ambient air (e.g., at high altitude), severe weather conditions, foreign object damage (FOD), and the like. Typically, when a flameout condition is detected during a flight of an aircraft, the flameout is only temporary as a relight procedure is implemented to re-ignite the combustion reaction within the combustor. However, re-ignition at altitude is difficult for combustors with small combustion volumes due to a reduced flow residence time within the combustion chambers compared to residence times within larger-volume combustors. For example, because of the low residence time, the air and fuel supplied to the combustion chamber during the relight procedure may be exhausted from the chamber before sufficient heat is released to re-ignite the self-sustaining deflagrative combustion reaction in the combustion chamber. Since gas turbine engines are used to provide thrust for supporting flight of aircraft, the ability to reliably re-ignite a gas turbine engine at high altitude after a flameout is a safety priority.

### SUMMARY

In an embodiment, a gas turbine engine combustor is provided that includes a dome plate, an inner liner, and an outer liner. The dome plate has a front side and a rear side and defines a central bore therethrough. The inner liner is coupled to the dome plate and extends rearward therefrom. The outer liner is coupled to the dome plate and extends rearward therefrom. The outer liner surrounds the inner liner and is radially spaced apart from the inner liner to define an annular combustion chamber therebetween that extends rearward from the dome plate. At least one of the outer liner or the dome plate includes an igniter cavity formed therein. The igniter cavity is separated from the combustion chamber by a partition wall of the at least one of the outer liner or the dome plate that includes the igniter cavity. The partition wall defines one or more transfer holes therethrough that fluidly connect the igniter cavity to the combustion chamber.

In an embodiment, a method (e.g., of assembling and/or operating a gas turbine engine combustor) is provided that includes forming an igniter cavity within at least one of an outer liner or a dome plate. The igniter cavity is defined between a partition wall and one or more cavity walls of the at least one of the outer liner or the dome plate that includes the igniter cavity. The partition wall includes one or more transfer holes extending therethrough. The method includes coupling an inner liner to the dome plate such that the inner liner extends rearward from the dome plate. The method also includes coupling the outer liner to the dome plate such that the outer line extends rearward from the dome plate and surrounds the inner liner. The outer liner is radially spaced apart from the inner liner to define an annular combustion chamber therebetween that extends rearward from the dome plate. The combustion chamber is separated from the igniter cavity by the partition wall and is fluidly connected to the igniter cavity through the one or more transfer holes in the partition wall.

In an embodiment, a gas turbine engine combustor is provided that includes a combustion chamber and an outer liner. The combustion chamber has an annular shape defined between an inner liner and the outer liner. A front end of the combustion chamber is defined by a dome plate extending between the inner liner and the outer liner. The dome plate has inlet openings therethrough that are positioned to allow a primary air stream and a main fuel stream into the combustion chamber for a primary combustion reaction of the gas turbine engine. The outer liner includes an igniter cavity formed therein. The igniter cavity is separated from the combustion chamber by a partition wall of the outer liner. The outer liner includes one or more cavity walls that define an injector opening for allowing an auxiliary fuel stream into the igniter cavity. The one or more cavity walls also define cooling holes for allowing a secondary air stream into the igniter cavity for a secondary combustion reaction of the gas turbine engine. The igniter cavity is fluidly connected with the combustion chamber via one or more transfer holes extending through the partition wall. The one or more transfer holes are positioned to direct heat generated by the secondary combustion reaction into the combustion chamber.

### BRIEF DESCRIPTION OF THE DRAWINGS

The present inventive subject matter will be better understood from reading the following description of non-limiting embodiments, with reference to the attached drawings, wherein below:

FIG. 1 illustrates a gas turbine engine according to an embodiment;

FIG. 2 is a schematic cross-sectional view of a combustor of the gas turbine engine according to an embodiment;

FIG. 3 is a perspective, cross-sectional view of a portion of the combustor according to an embodiment;

FIG. 4 is a schematic cross-sectional illustration of the combustor according to an embodiment;

FIG. 5 is a close-up view of a cavity of the combustor illustrated in FIG. 4;

FIG. 6 is a schematic cross-sectional illustration of the combustor shown in FIG. 4 according to an alternative embodiment;

FIG. 7 is a schematic cross-sectional illustration of the combustor according to another alternative embodiment; and

FIG. 8 is a flow chart of a method of assembling and operating a gas turbine engine combustor according to an embodiment.

### DETAILED DESCRIPTION

Embodiments of the inventive subject matter described herein provide a gas turbine engine combustor that enables reliable relight of the gas turbine engine at altitude after a flameout. The combustor has a dome, an outer liner, and an inner liner that define a combustion chamber in which a primary combustion reaction occurs. To enable successful relight after a flameout, an igniter cavity is integrated into the dome and/or the outer liner near the front of the combustion chamber. The igniter cavity is a discrete space that is separate from the combustion chamber, but is fluidly connected to the combustion chamber via one or more holes in a partition wall that extends between the igniter cavity and the combustion chamber. The volumetric sizes of the igniter cavity and the combustion chamber may be significantly larger than the channels or holes that fluidly couple the igniter cavity with the combustion chamber (e.g., 100 times larger, 1,000 times larger, or the like). The igniter cavity receives airflow from a compressor of the gas turbine engine through cooling holes in the walls of the dome and/or outer liner. The igniter cavity also receives an independent fuel stream that is discrete from the fuel stream that is supplied into the combustion chamber. For example, the gas turbine engine may be operated such that fuel is directly injected into the igniter cavity during startup (e.g., cold start) and relight conditions to provide a secondary combustion reaction within the igniter cavity that is different from the primary combustion reaction within the combustion chamber.

The igniter cavity has a size and shape that allows circulation of flowing gases therein, which increases the flow residence time of the combustor during the startup and relight conditions of the gas turbine engine. The increase in residence time provided by the igniter cavity can support ignition of the primary combustion reaction in the combustion chamber. The igniter cavity may also serve as a resonator (e.g., a Helmholtz resonator or a quarter wave tube) within the combustor that provides acoustic abatement at one or more frequencies of interest. For example, the igniter cavity can be formed to have a specific size such that the igniter cavity dampens high frequency combustion dynamics (e.g., pressure waves) within the combustor during high power operating conditions of the gas turbine engine.

The combustor may be configured to be used at high operating pressure ratios, such as pressure ratios of at least 60:1. For example, the igniter cavity may lower combustion instabilities at high operating pressure ratios by acting as a Helmholtz resonator. The secondary combustion reaction within the igniter cavity may increase the reliability of re-ignition of the primary combustion reaction at high operating pressure ratios.

At least one technical effect of the subject matter described herein includes improving the ability of a gas turbine engine at altitude to relight after a flameout. Another technical effect of the subject matter described herein may include reducing the size of the combustor, which allows for a reduced length and/or weight of the gas turbine engine. Yet another technical effect may include improving combustor durability and stability due to damping of high frequency combustion dynamics within the combustor. The damping of the high frequency combustion dynamics may reduce the risk of turbine-damaging vibrations or even explosion.

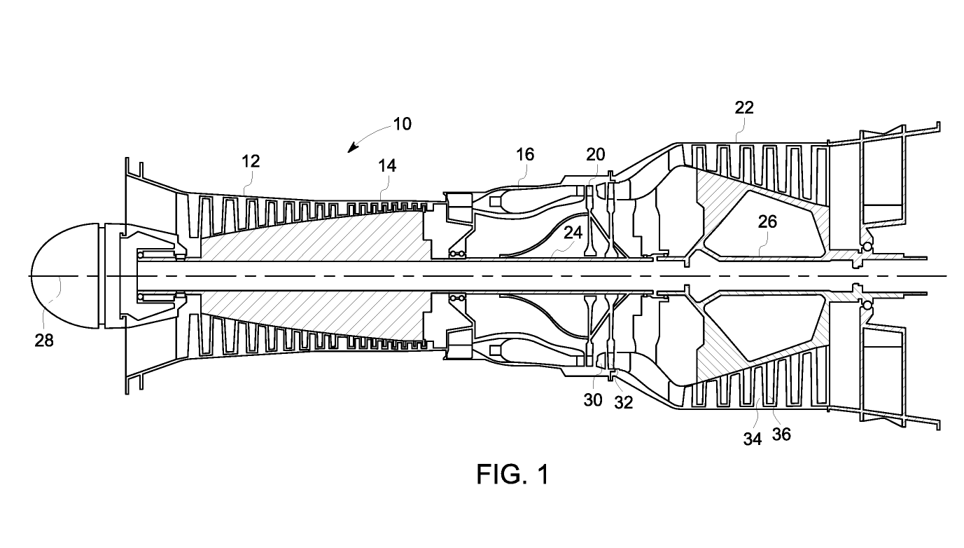

FIG. 1 illustrates a gas turbine engine 10 according to an embodiment. The gas turbine engine 10 has a low pressure compressor 12, a high pressure compressor 14, and a combustor 16 in serial flow communication. The combustor 16 generates combustion gases that are discharged from the combustor 16 through a high pressure turbine 20 and subsequently to a low pressure turbine 22. The high pressure turbine 20 may drive the high pressure compressor 14 through a first shaft 24, and the low pressure turbine 22 drives the low pressure compressor 12 through a second shaft 26. The compressors 12, 14, turbines 20, 22, and shafts 24, 26 are all disposed coaxially along a longitudinal or axial centerline axis 28. The gas turbine engine 10 may be a high-bypass turbofan jet engine that is mounted to an aircraft. Optionally, the engine 10 may be included in another type of vehicle or may be a stationary power-generating engine 10 mounted to a surface.

During operation of the gas turbine engine 10, a stream of air (indicated by arrow 18) is directed into an inlet of the low pressure turbine 22. The pressure of the air increases as the stream is routed through the low pressure turbine 22 and the high pressure turbine 20 before entering the combustor 16. In the combustor 16, the highly pressurized air is mixed with fuel and burned to provide combustion gases. The combustion gases discharged from the combustor enter and expand through the high pressure turbine 20, where a portion of thermal and/or kinetic energy from the combustion gases is extracted via sequential stages of turbine stator vanes 30 and rotor blades 32. The rotor blades 32 are coupled to the first shaft 24, and the combustion gases cause the blades 32 to rotate the shaft 24, thereby supporting operation of the high pressure compressor 14. After passing beyond the high pressure turbine 20, the combustion gases flow through the low pressure turbine 22 where a second portion of thermal and kinetic energy is extracted from the combustion gases via sequential stages of turbine stator vanes 34 and turbine rotor blades 36. Similar to the rotor blades 32 of the high pressure turbine 20, the rotor blades 36 are coupled to the second shaft 26, such that the force of the combustion gases on the blades 36 cause the second shaft 26 to rotate, supporting operation of the low pressure turbine 12. Although not shown, the combustion gases may be subsequently exhausted from the gas turbine engine through an exhaust nozzle to provide propulsive thrust.

It should be appreciated that the gas turbine engine 10 depicted in FIG. 1 is an example only, and that in other embodiments, the gas turbine engine 10 may have different suitable configurations, such as different compressor and/or turbine configurations. It also should be appreciated that aspects of the present disclosure may be incorporated into another suitable gas turbine engine other than the gas turbine engine 10 shown in FIG. 1. For example, in one or more other embodiments, aspects of the present disclosure may be incorporated into a turboshaft engine, a turboprop engine, a turbocore engine, a turbojet engine, or the like.

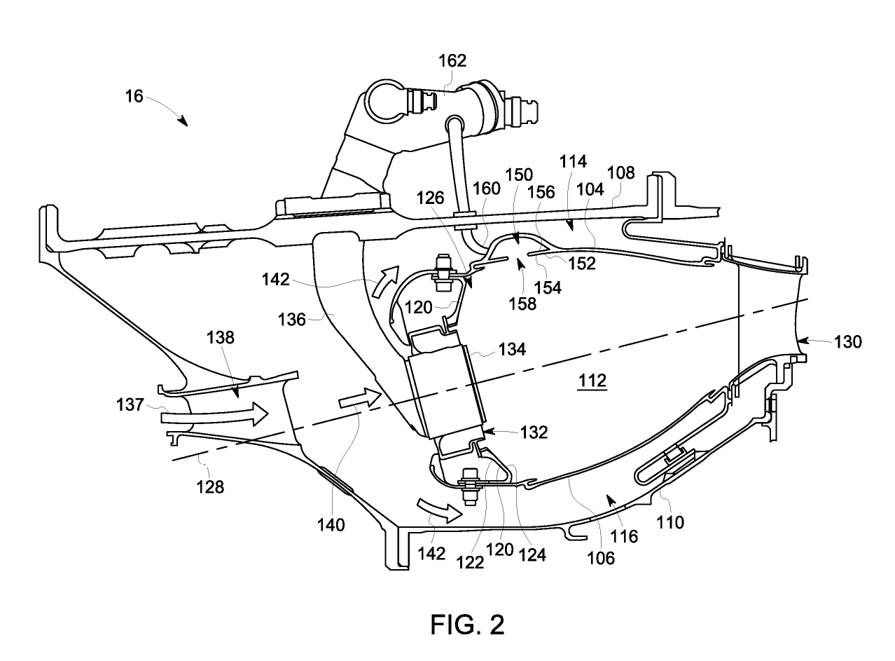

FIG. 2 is a schematic cross-sectional view of the combustor 16 of the gas turbine engine 10 according to an embodiment. The combustor 16 includes an outer liner 104 and an inner liner 106 disposed between an outer casing 108 and an inner casing 110. The outer liner 104 surrounds the inner liner 106 and is radially spaced apart from the inner liner 106 to define a combustion chamber 112 therebetween. The outer liner 104 is spaced apart from the outer casing 108 to define an outer duct 114 between the outer casing 108 and the outer liner 104. Similarly, the inner liner 106 is spaced apart from the inner casing 110 to define an inner duct 116 between the inner liner 106 and the inner casing 110.

The combustor 16 includes a dome plate 120 that is coupled to the outer and inner liners 104, 106. The dome plate 120 has a front side 122 and an opposite, rear side 124. The outer liner 104 and the inner liner 106 are each coupled to the rear side 124 and extend rearward from the rear side 124. The dome plate 120 extends between the outer liner 104 and the inner liner 106, defining a front end 126 of the combustion chamber 112. The combustion chamber 112 extends along a longitudinal axis 128 from the front end 126 to an opposite, rear end 130. The longitudinal axis 128 may be parallel to the centerline axis 28 shown in FIG. 1. The rear end 130 is open to define a discharge port for emitting a reaction product stream from the combustor 16.

The dome plate 120 includes multiple inlet openings 132 positioned to allow a fuel stream and a compressed air stream into the combustion chamber 112. In an embodiment, each inlet opening 132 includes a swirler assembly 134 associated with the corresponding inlet opening 132. Only one inlet opening 132 and one swirler assembly 134 are shown in FIG. 2. The swirler assembly 134 is located within the inlet opening 132 and receives the fuel stream and the compressed air stream. The swirler assembly 134 is configured to swirl and mix the fuel and air together, and the resulting fuel/air mixture is discharged into combustion chamber 112. The fuel stream that is supplied into the combustion chamber 112 is provided by a fuel injector 136 coupled to the swirler assembly 134. Although not shown in FIG. 2, the fuel injector 136 may protrude through the inlet opening 132 and the swirler assembly 134 into the combustion chamber 112. The fuel injector 136 is referred to herein as a first fuel injector 136, and the fuel stream supplied by the first fuel injector 136 is referred to herein as a main fuel stream. In the exemplary embodiment, combustor 16 is a single annular combustor, but the combustor 16 may be a double annular combustor in an alternative embodiment.

In the illustrated embodiment, incoming compressed air (indicated by arrow 137) from the high pressure compressor 14 (shown in FIG. 1) is directed through a diffuser 138 into the combustor 16. The diameter of the diffuser 138 increases gradually with increasing proximity to the combustor 16. Within the combustor 16, a first portion of the compressed airflow, referred to herein as a primary air stream 140, is directed into the swirler assemblies 134 through the inlet openings 132 of the dome plate 120 into the combustion chamber 112. The primary air stream 140 mixes within the main fuel stream within the swirler assembly 134 and within the combustion chamber 112 to provide a primary combustion reaction of the gas turbine engine 10. Although not shown in FIG. 2, the combustor 16 may include an igniter extending into the combustion chamber 112 that is configured to provide a spark to ignite the primary combustion reaction. Once the primary combustion reaction is ignited, continuous supplies of the main fuel stream from the first fuel injector 136 and the primary air stream 140 from the compressor 14 sustain the primary combustion reaction, unless an unintentional disturbance causes a flameout. The primary combustion reaction generates high energy reaction exhaust gases that propel the rotation of the turbines 20, 22 (shown in FIG. 1) and/or provide propulsive thrust when discharged from the gas turbine engine 10.

A second portion of the compressed airflow 137, referred to herein as a secondary air stream 142, bypasses the swirler assemblies 134 and the inlet openings 132 of the dome plate 120 and does not enter the combustion chamber 112. The secondary air stream 142 is diverted along an outside of the outer and inner liners 104, 106 through the outer and inner ducts 114, 116, respectively. The secondary air stream 142 is used for cooling the liners 104, 106 and other structural components of the combustor 16 exposed to the high combustion temperatures, which may exceed 2500° F. In addition, the outer liner 104 and/or the inner liner 106 may have a thermal barrier coating applied on the interior surfaces thereof that are exposed to the high temperature combustion fluids. The secondary air stream 142 in one or more embodiments is also used to provide compressed airflow into an igniter cavity 150 for a secondary combustion reaction of the gas turbine engine 10. The secondary combustion reaction is a separate reaction from the primary combustion reaction. The secondary combustion reaction, as described in more detail herein, is used to sustain and/or initiate the primary combustion reaction, such as during a cold start of the gas turbine engine 10 or during a relight after a flameout of the gas turbine engine 10.

The igniter cavity 150 (also referred to herein simply as cavity 150) is located at or near the front end 126 of the combustion chamber 112. For example, the cavity 150 may be located at the dome plate 120 or proximate to, but rear of the dome plate 120. In the illustrated embodiment, the igniter cavity 150 is within the outer liner 104 and located rearward of the dome plate 120, but may be partially or entirely within the dome plate 120 in one or more alternative embodiments. In the illustrated embodiment, the cavity 150 in the outer cavity 104 is located proximate to, but spaced apart from, the dome plate 120.

In FIG. 2, the cavity 150 is disposed in the outer liner 104 radially outward of the combustion chamber 112 relative to the longitudinal axis 128. The cavity 150 is separated from the combustion chamber 112 by a partition wall or septum 152 of the outer liner 104. For example, the partition wall 152 includes an interior surface 154 and an opposite, exterior surface 156. The interior surface 154 defines a portion of the outer perimeter of the combustion chamber 112. The exterior surface 156 defines a portion of the inner perimeter of the cavity 150. The partition wall 152 defines one or more transfer holes 158 that extend fully through the partition wall 152 between the interior and exterior surfaces 154, 156. The one or more transfer holes 158 fluidly connect the cavity 150 to the combustion chamber 112. Only one transfer hole 158 is visible in the illustrated embodiment.

The cavity 150 is configured to receive an auxiliary fuel stream that is separate from the main fuel stream injected into the combustion chamber 112. The auxiliary fuel stream mixes with air from the secondary air stream 142 within the cavity 150 to provide the secondary combustion reaction. The auxiliary fuel stream is supplied into the cavity 150 from a second fuel injector 160 that is different from the first fuel injector 136. The second fuel injector 160 in the illustrated embodiment extends through the outer casing 108 at a separate location from the first fuel injector 136. Optionally, the first and second fuel injectors 136, 160 are connected to a common fuel nozzle body 162 outside of the casing 108. The second fuel injector 160 may be coupled to the fuel nozzle body 162 by a bolted joint or a fitting. In an alternative embodiment, the second fuel injector 160 may be integrated onto the first fuel injector 136 to form an integrated fuel nozzle assembly.

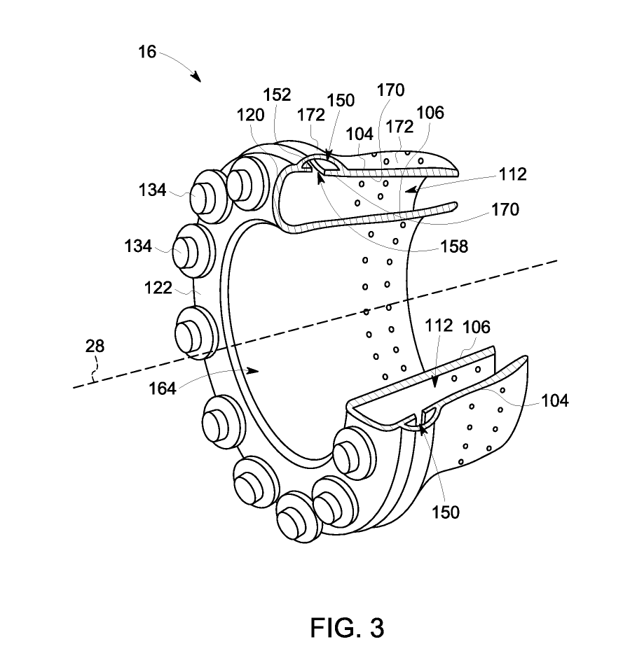

FIG. 3 is a perspective, cross-sectional view of a portion of the combustor 16 according to an embodiment. The illustrated portion of the combustor 16 includes the dome plate 120, the outer liner 104, and the inner liner 106. As shown in FIG. 3, the dome plate 120 is annular and is oriented about the centerline axis 28. The dome plate 120 defines a central bore 164 therethrough. In an embodiment, the central bore 164 is configured to receive both the first and second shafts 24, 26 (shown in FIG. 1). The outer and inner liners 104, 106 have generally cylindrical shapes, although the diameters of the liners 104, 106 may vary along the lengths of the liners 104, 106.

As shown in FIG. 3, the dome plate 120 includes multiple swirler assemblies 134 disposed around a circumference of the dome plate 120. The swirler assemblies 134 protrude from the front side 122 of the dome plate 120. Each of the swirler assemblies 134 is associated with a different inlet opening 132 (shown in FIG. 2). The main fuel stream and the primary air stream are supplied into the annular combustion chamber 112 at different locations along the circumference of the chamber 112 through the swirler assemblies 134.

In the illustrated embodiment, the cavity 150 in the outer liner 104 has an annular shape and extends fully around the circumference of the outer liner 104. In an alternative embodiment, the cavity 150 may only extend around a portion of the circumference of the outer liner 104. Optionally, the cavity 150 may be a first cavity of multiple cavities in the outer liner 104 that are isolated from one another. For example, the multiple cavities may be spaced apart at different locations along the circumference of the outer liner 104 and/or at different locations along an axial length of the outer liner 104. Although not shown in FIG. 3, the combustor 16 may include multiple second fuel injectors 160 (shown in FIG. 2) installed at different locations along the circumference of the combustor 16 via separate openings in the outer casing 108 (FIG. 2). The number of fuel injectors 160 that supply fuel into the igniter cavity 150 may be less than or equal to the number of fuel injectors 136 that supply fuel into the combustion chamber 112. The transfer hole 158 of the partition wall 152 in FIG. 3 is an annular slot extending continuously around the circumference of the combustion chamber 112. Alternatively, the annular slot 158 may include multiple holes or multiple slots instead of a single annular slot.

The outer liner 104 has a thickness defined between an interior surface 170 of the outer liner and an exterior surface 172 of the outer liner. The cavity 150 is located within the outer liner 104 between the interior surface 170 and the exterior surface 172. The thickness of the outer liner 104 at the location of the cavity 150 is greater than the thickness of the outer liner 104 at a location rearward of the cavity 150. For example, in FIG. 3 the outer liner 104 bulges radially outward in the location of the cavity 150. The liner dimensions may depend on the location of the cavity 150.

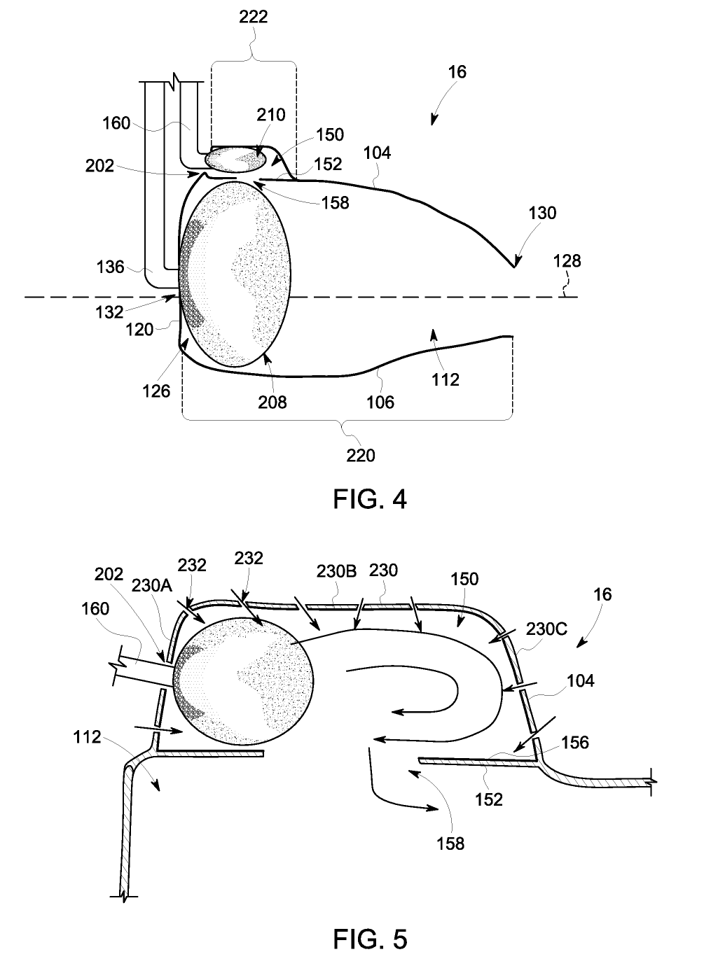

FIG. 4 is a schematic cross-sectional illustration of the combustor 16 according to an embodiment. FIG. 4 shows the dome plate 120, the outer liner 104, and the inner liner 106. FIG. 4 also shows the first and second fuel injectors 136, 160. The first fuel injector 136 extends through one of the inlet openings 132 in the dome plate 120 and injects the main fuel stream into the combustion chamber 112. The second fuel injector 160 extends through an injector opening 202 in the outer liner 104 and injects the auxiliary fuel stream into the cavity 150. The first fuel injector 136 is separate from the second fuel injector 160, but the fuel injectors 136, 160 optionally may be connected to a common fuel nozzle body 162 (shown in FIG. 2). The main fuel stream may be the same type of fuel as the auxiliary fuel stream, and may come from the same fuel supply. Although not shown in FIG. 4, the fuel injectors 136, 160 may include, or be fluidly connected to, various valves and pumps that separately control the flow of fuel through the fuel injectors 136, 160. The first fuel injector 136 may be controlled to supply the fuel to the combustion chamber 112 at a different flow rate and/or at different times than the second fuel injector 160 is controlled to supply the fuel to the cavity 150. For example, the main fuel stream may be supplied at a greater flow rate than the auxiliary fuel stream.

FIG. 4 shows the primary combustion reaction 208 within the combustion chamber 112 occurring concurrently with the secondary combustion reaction 210 within the cavity 150. As shown in FIG. 4, the primary combustion reaction 208 occurs proximate to the front end 126 of the combustion chamber 112, where the fuel and air mixture enters the combustion chamber 112. In an embodiment, the one or more transfer holes 158 of the partition wall 152 are also located proximate to the front end 126 of the chamber 112. For example, the transfer holes are located more proximate to the front end 126 than the rear end 130 of the combustion chamber 112. The transfer holes 158 are positioned to direct heat generated by the secondary combustion reaction 210 into the combustion chamber 112 through the one or more transfer holes 158. The heat from the cavity 150 is configured to sustain and/or support initiation of the primary combustion reaction 208 within the combustion chamber 112. For example, as shown in FIG. 4, the heat entering the combustion chamber 112 through the transfer hole 158 aligns generally with the location of the primary combustion reaction 208.

In an embodiment, the cavity 150 is smaller in volumetric size than the combustion chamber 112. For example, the combustion chamber 112 extends a first length 220 along the longitudinal axis 128 from the dome plate 120 to the rear end 130. The cavity 150 has a second length 222 that is less than one-third of the first length 220 of the combustion chamber 112. For example, the first length 220 of the combustion chamber 112 may be between about 15 cm and about 30 cm, and the second length 222 of the cavity 150 may between about 2 cm and about 6 cm along the axis 128. The volume of the cavity 150 may be less than one-third of the volume of the combustion chamber 112, such as less than one-ninth of the volume of the combustion chamber 112.

FIG. 5 is a close-up view of the cavity 150 of the combustor 16 illustrated in FIG. 4. The cavity 150 is defined by the exterior surface 156 of the partition wall 152 and one or more cavity walls 230. The one or more cavity walls 230 define the outer perimeter or periphery of the cavity 150. In the illustrated embodiment, the outer liner 104 includes multiple cavity walls 230 including a front cavity wall 230A, an intermediate cavity wall 230B, and a rear cavity wall 230C. The front cavity wall 230A defines a front end of the cavity 150 and includes the injector opening 202 that receives the second fuel injector 160. The cavity walls 230A-C also include cooling holes 232 for allowing airflow from the secondary air stream from the outer and inner ducts 114, 116 (shown in FIG. 2) into the cavity 150. The flow of air through the cooling holes 232 provides a thermal barrier that protects the outer liner 104 (including the cavity walls 230A-C and the partition wall 152) from high combustion temperatures. Furthermore, at least some of the air entering the cavity 150 through the cooling holes 232 may react with the auxiliary fuel stream to provide the secondary combustion reaction. Optionally, the cavity walls 230A-C may be porous, and the cooling holes 232 may be pores that extend through the porous walls 230A-C. In an alternative embodiment, one or more of the cavity walls 230A-C may include an opening discrete from the cooling holes 232 for allowing the secondary air stream into the cavity 150 to react with the auxiliary fuel stream. In another alternative embodiment, the outer liner 104 may include a single curved cavity wall 230 that defines the outer perimeter of the cavity 150 instead of the three walls 230A-C shown in FIG. 5.

The cavity 150 may represent a circulation zone that increases the residence time of the gases within the combustor 16 (e.g., relative to engines that do not include the cavity 150). For example, the reaction products from the secondary combustion reaction may circulate, at least momentarily, within the cavity 150 before exiting through the transfer hole 158 into the combustion chamber 112. The circulation of the reaction products within the cavity 150 increases the residence time of gases within the combustor 16 before being discharged from the combustor 16. In an example embodiment, if a flameout occurs during a flight such that the primary combustion reaction is temporarily extinguished, it may be difficult for short conventional combustors with short residence times to relight the primary combustion reaction at altitude. But, the circulation zone within the cavity 150 allows the secondary combustion reaction to reliably ignite, even at high altitude. Furthermore, the heat from the secondary combustion reaction that enters the combustion chamber 112 increases the temperature of the fuel-and-air mixture within the combustion chamber 112, which supports the re-ignition of the primary combustion reaction. Thus, the presence of the cavity 150 allows for more reliable and faster re-ignition of the primary combustion reaction within the combustion chamber 112 during relight conditions (e.g., relative to engines that do not include the cavity 150). The secondary combustion reaction can also be used to support ignition of the primary combustion reaction during cold starts.

In an embodiment, the cavity 150 may also serve as a damping resonator, or more specifically a Helmholtz resonator. For example, air in the cavity 150 is fluidly connected to the combustion chamber 112 via the one or more transfer holes 158. During operation of the combustor 16, high frequency combustion dynamics (e.g., pressure waves) due to the primary combustion reaction may aggregate within the combustion chamber 112, leading to potentially damaging vibrations and destabilizing the primary combustion reaction. The cavity 150 in an embodiment has a size that is specifically configured to dampen pressure oscillations or waves within the combustion chamber 112 in a designated frequency of interest. For example, the pressure oscillations that enter the cavity 150 may cancel out some pressure oscillations at certain frequencies when the pressure oscillations return to the combustion chamber 112. The size of the cavity 150 affects the frequencies that are dampened. In an embodiment, the cavity 150 may be formed with a first size in order to dampen pressure oscillations in a first frequency range, may be formed with a smaller size than the first size to dampen pressure oscillations in a second, higher frequency range, and may be formed with a larger size than the first size to dampen pressure oscillations in a third frequency range that is lower than the first frequency range.

In order to configure the size of the cavity 150 to dampen one or more specific frequencies of interest, different engines may be constructed that are identical except for having different sized cavities 150. The different engines may be operated, and the vibrations at one or more frequencies can be measured (e.g., at different throttle or other settings). The cavity size that reduces the vibrations at a frequency of interest more than one or more (or all) other cavity sizes can then be selected as the designated cavity size. The cavities in the outer liner of subsequently-created engines may be formed to have the designated cavity size (as this size is specifically configured to dampen pressure oscillations or waves within the combustion chamber in the frequency of interest).

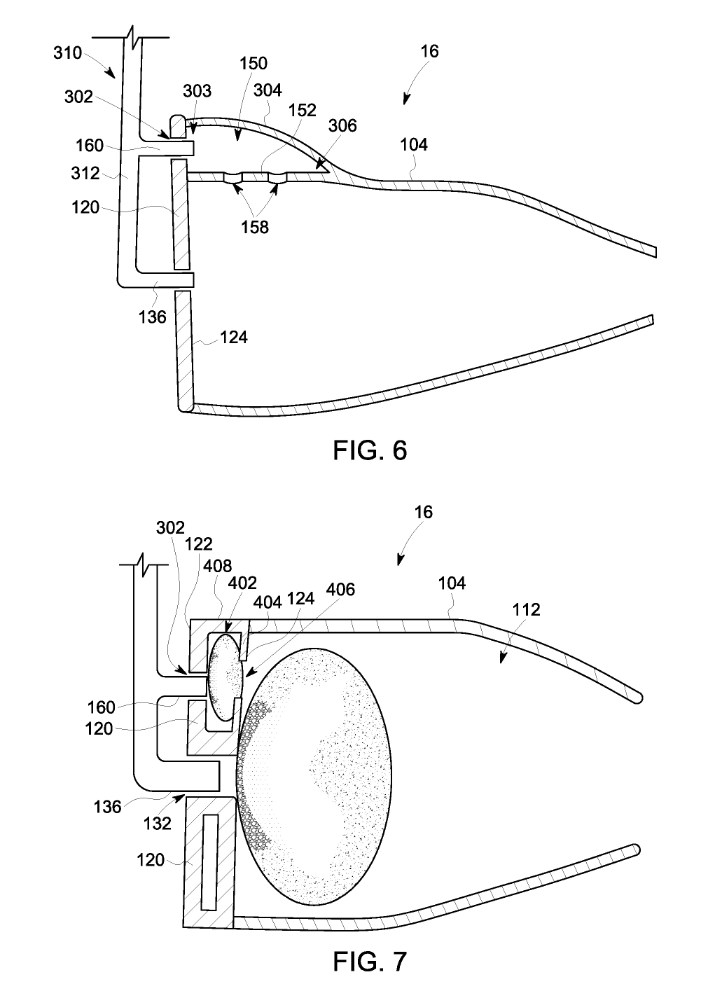

FIG. 6 is a schematic cross-sectional illustration of the combustor 16 according to an alternative embodiment. In the illustrated embodiment, the cavity 150 is located at the dome plate 120 and extends rearward from the dome plate 120 instead of being spaced apart axially from the dome plate 120, as shown in FIG. 4. For example, in FIG. 6, the rear side 124 of the dome plate 120 defines a front end 303 of the cavity 150. The dome plate 120 includes an injector opening 302 through which the second fuel injector 160 injects fuel into the cavity 150. The outer liner 104 includes a single curved cavity wall 304 that defines an outer perimeter of the cavity 150 from the dome plate 150 to a rear end 306 of the cavity 150. The partition wall 152 in the illustrated embodiment includes multiple transfer holes 158. In addition, the second fuel injector 160 is integrated onto the first fuel injector 136 in the illustrated embodiment to form an integrated fuel nozzle assembly 310. For example, the first and second fuel injectors 136, 160 branch off from a common fuel stem 312 at different locations along the length of the stem 312. The integrated fuel nozzle assembly 310 may be installed through a single opening in the outer casing 108 (shown in FIG. 2). Although not shown, the fuel nozzle assembly 310 may include valves and piping that are configured to differentiate the amount of fuel supplied through the first and second fuel injectors 136, 160. Optionally, the combustor 16 may include both the integrated fuel nozzle assemblies 310 and the discrete first fuel injectors 136 (as shown in FIG. 2) arranged along a circumference of the combustor 16.

FIG. 7 is a schematic cross-sectional illustration of the combustor 16 according to another alternative embodiment. In the illustrated embodiment, an igniter cavity 402 is defined within the dome plate 120 between the front side 122 and the rear side 124. The igniter cavity 402 is disposed radially outward of the central bore 164 (shown in FIG. 3), and radially interior of the outer liner 104. The igniter cavity 402 is separated from the combustion chamber 112 by a partition wall 404. For example, the partition wall 404 extends along the rear side 124 of the dome plate 120, and the igniter cavity 402 is located in front of the combustion chamber 112. The igniter cavity 402 therefore may be co-linear with the combustion chamber 112, instead of located outward of the combustion chamber 112 as shown in FIGS. 2-6. In the illustrated embodiment, the partition wall 404 and the cavity walls that surround and define the igniter cavity 402 are all components of the dome plate 120. Alternatively, the outer liner 104 may define at least one of the cavity walls such that the igniter cavity 402 is partially defined by the dome plate 120 and partially defined by the outer liner 104. The partition wall 404 and/or the cavity walls of the dome plate 120 may be coated in a thermal barrier coating for protection from the high temperature combustion fluids within the igniter cavity 402.

Although not shown in FIG. 7, the igniter cavity 402 may have an annular shape that extends circumferentially through the dome plate 120. For example, the igniter cavity 402 may be elongated along the entire circumference of the dome plate 120, forming a closed ring-shaped cavity, or the igniter cavity 402 may extend along only a portion of the circumference of the dome plate 120. Optionally, the igniter cavity 402 may be one of multiple cavities formed in the dome plate 120. The multiple cavities may be isolated from each other and spaced apart radially and/or circumferentially from each other.

The first fuel injector 136 extends through one of the inlet openings 132 in the dome plate 120 and injects the main fuel stream in to the combustion chamber 112. In the illustrated embodiment, the dome plate 120 further includes the injector opening 302 through which the second fuel injector 160 extends to inject the auxiliary fuel stream into the igniter cavity 402. The injector opening 302 is located on the front side 122 of the dome plate 120 in the illustrated embodiment, but may extend through an outer side 408 of the dome plate 120 or through the outer liner 104 in an alternative embodiment. Although not shown in FIG. 7, the dome plate 120 defines cooling holes that allow air from the secondary air stream to penetrate through the walls of the dome plate 120 into the igniter cavity 402. The air within the igniter cavity 402 mixes with the fuel from the auxiliary fuel stream and combusts in the secondary combustion reaction. The partition wall 404 includes one or more transfer holes 406 that are positioned to direct heat generated by the secondary combustion reaction into the combustion chamber to support (e.g., sustain or ignite) the primary combustion reaction.

Like the igniter cavity 150 described with reference to FIGS. 2-6, the igniter cavity 150 may function as a resonator for acoustics abatement (e.g., a Helmholtz resonator or a quarter wave tube). For example, the igniter cavity 150 may be sized to dampen pressure oscillations within the combustion chamber 112 in a designated frequency of interest.

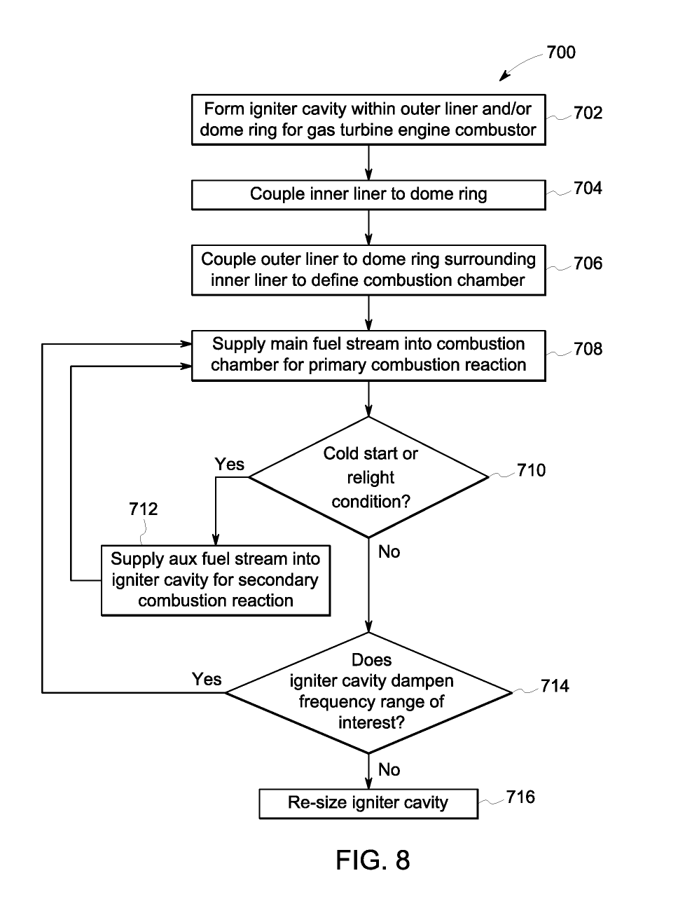

FIG. 8 is a flow chart of a method 700 of assembling and operating a combustor for a gas turbine engine according to an embodiment. The combustor may be the combustor 16 according to any of the embodiments shown in FIGS. 1 through 7. At 702, an igniter cavity is formed within an outer liner and/or a dome plate for a gas turbine engine combustor. For example, the igniter cavity may be formed entirely within the outer liner between an interior surface and an exterior surface thereof, may be formed entirely within the dome plate between a front side and a rear side thereof, or may be formed at least partially by each of the dome plate and the outer liner. The igniter cavity is defined between cavity walls and a partition wall of the outer liner and/or dome plate. The partition wall includes one or more transfer holes extending therethrough.

At 704, an inner liner is coupled to the dome plate and extends rearward from the rear side of the dome plate. At 706, the outer liner is coupled to the dome plate and also extends rearward from the rear side of the dome plate. The outer liner surrounds the inner liner and is radially spaced apart from the inner liner to define an annular combustion chamber therebetween. The combustion chamber is separated from the igniter cavity by the partition wall. The combustion chamber is fluidly connected to the igniter cavity through the one or more transfer holes in the partition wall. The outer liner is oriented along a longitudinal axis between a front end and a rear end of the outer liner. The front end of the outer liner is coupled to the dome plate, and the dome plate defines front end of the combustion chamber. The igniter cavity is located at or proximate to the front end of the combustion chamber.

At 708, a main fuel stream is supplied into the combustion chamber for a primary combustion reaction of the gas turbine engine. The main fuel stream is supplied into the combustion chamber via a first fuel injector that may be coupled to the dome plate. The first fuel injector may inject the main fuel stream through an inlet opening in the dome plate into the combustion chamber.

At 710, a determination is made whether the gas turbine engine is experiencing a cold start condition or a relight condition. The cold start condition refers to start-up of the gas turbine engine after a period of inactivity in which the gas turbine engine components are at ambient temperature. The relight condition refers to a restart of the gas turbine engine after an unintentional flameout in which the primary combustion reaction extinguished. If a cold start or relight condition is present, the flow proceeds to 712.

At 712, an auxiliary fuel stream is supplied into the igniter cavity (that is within the outer liner and/or the dome plate) for a secondary combustion reaction. The auxiliary fuel stream may be supplied by a second fuel injector through an injector opening in the dome plate or the outer liner. The igniter cavity receives a secondary air stream therein through cooling holes or other openings in the cavity walls of the outer liner and/or dome plate. Concurrently, the main fuel stream may be supplied to the combustion chamber. Heat from the secondary combustion reaction is discharged through the one or more transfer holes of the partition wall into the combustion chamber to support ignition of the primary combustion reaction. After the primary combustion reaction is successfully ignited, the second fuel injector may be controlled to cease supplying the auxiliary fuel stream into the igniter cavity, and the flow may return to 708.

If it is determined that there is no cold-start or relight condition, then flow continues to 714, and a determination is made whether the igniter cavity dampens a designated frequency (or frequency range) of interest. For example, the igniter cavity may function as a Helmholtz resonator that dampens pressure waves or oscillations of certain frequencies within the combustion chamber during operation of the combustor. If it is determined that the igniter cavity successfully dampens a frequency of interest, then flow returns to 708 for continued operation of the combustor. If, on the other hand, the igniter cavity does not dampen a certain designated frequency or range of frequencies, then flow proceeds to 716 and the igniter cavity is re-sized. For example, the size of the igniter cavity may be reduced to dampen higher frequencies than the frequencies previously dampened, and the size of the igniter cavity may be increased to dampen lower frequencies. The igniter cavity may be re-sized by re-forming the cavity within the outer liner and/or the dome plate, inserting damping materials into the igniter cavity, or by forming a new igniter cavity within a new outer liner and/or dome plate.

In an embodiment, a gas turbine engine combustor is provided that includes a dome plate, an inner liner, and an outer liner. The dome plate has a front side and a rear side and defines a central bore therethrough. The inner liner is coupled to the dome plate and extends rearward therefrom. The outer liner is coupled to the dome plate and extends rearward therefrom. The outer liner surrounds the inner liner and is radially spaced apart from the inner liner to define an annular combustion chamber therebetween that extends rearward from the dome plate. At least one of the outer liner or the dome plate includes an igniter cavity formed therein. The igniter cavity is separated from the combustion chamber by a partition wall of the at least one of the outer liner or the dome plate that includes the igniter cavity. The partition wall defines one or more transfer holes therethrough that fluidly connect the igniter cavity to the combustion chamber.

Optionally, the igniter cavity is in the dome plate between the front side and the rear side outward of the central bore. The partition wall extends along the rear side of the dome plate. The igniter cavity is disposed in front of the combustion chamber.

Optionally, the igniter cavity is in the outer liner between an interior surface of the outer liner and an exterior surface of the outer liner. The igniter cavity is disposed radially outward of the combustion chamber and rearward of the dome plate. Optionally, the rear side of the dome plate defines a front end of the igniter cavity. Optionally, the igniter cavity is spaced apart rearward from the rear side of the dome plate, and the outer liner includes a front cavity wall that defines a front end of the igniter cavity. Optionally, a thickness of the outer liner between the interior surface and the exterior surface is greater at a location of the igniter cavity than at a location rearward of the igniter cavity.

Optionally, at least one of the outer liner or the dome plate includes an injector opening positioned to allow an auxiliary fuel stream into the igniter cavity, and also includes cooling holes for allowing a secondary air stream into the igniter cavity for a secondary combustion reaction of the gas turbine engine. The one or more transfer holes in the partition wall are positioned to direct heat generated by the secondary combustion reaction into the combustion chamber. Optionally, the heat generated by the secondary combustion reaction that is directed through the one or more transfer holes in the partition wall into the combustion chamber is configured to one or more of sustain or initiate a primary combustion reaction of the gas turbine engine within the combustion chamber.

Optionally, an interior surface of the partition wall defines a portion of the combustion chamber, and an opposite, exterior surface of the partition wall defines a portion of the igniter cavity.

Optionally, the igniter cavity has an annular shape and extends along an entire circumference of the at least one of the outer liner or the dome plate that includes the igniter cavity.

Optionally, the igniter cavity is a first cavity that extends along a portion of a circumference of the at least one of the outer liner or the dome plate that includes the igniter cavity. The at least one of the outer liner or the dome plate that includes the igniter cavity further includes a second cavity that is isolated from the first cavity and spaced apart from the first cavity along the circumference.

Optionally, the combustion chamber extends rearward from the dome plate along a longitudinal axis for a length to a rear end of the combustion chamber. The igniter cavity has a length along the longitudinal axis that is less than one-third of the length of the combustion chamber.

Optionally, the combustor further includes a first fuel injector and a second fuel injector. The first fuel injector extends through an inlet opening in the dome plate and is configured to supply a main fuel stream into the combustion chamber for a primary combustion reaction of the gas turbine engine. The second fuel injector extends through an injector opening in the dome plate or the outer liner and is configured to supply an auxiliary fuel stream into the igniter cavity for a secondary combustion reaction of the gas turbine engine.

Optionally, the igniter cavity has a size configured to dampen pressure oscillations within the combustion chamber in a designated frequency of interest.

In an embodiment, a method (e.g., of assembling and/or operating a gas turbine engine combustor) is provided that includes forming an igniter cavity within at least one of an outer liner or a dome plate for a combustor of a gas turbine engine. The igniter cavity is defined between a partition wall and one or more cavity walls of the at least one of the outer liner or the dome plate that includes the igniter cavity. The partition wall includes one or more transfer holes extending therethrough. The method includes coupling an inner liner to the dome plate such that the inner liner extends rearward from the dome plate. The method also includes coupling the outer liner to the dome plate such that the outer line extends rearward from the dome plate and surrounds the inner liner. The outer liner is radially spaced apart from the inner liner to define an annular combustion chamber therebetween that extends rearward from the dome plate. The combustion chamber is separated from the igniter cavity by the partition wall and is fluidly connected to the igniter cavity through the one or more transfer holes in the partition wall.

Optionally, the method further includes supplying a main fuel stream via a first fuel injector into the combustion chamber through an inlet opening in the dome plate for a primary combustion reaction of the gas turbine engine. The method also includes supplying an auxiliary fuel stream via a second fuel injector into the igniter cavity through an injector opening in the dome plate or the outer liner for a secondary combustion reaction of the gas turbine engine.

Optionally, the outer liner extends along a longitudinal axis between a front end and a rear end thereof. The front end of the outer liner is coupled to the dome plate. The igniter cavity is formed in the outer liner and is located more proximate to the front end than the rear end.

Optionally, the method further includes sizing the igniter cavity such that the igniter cavity dampens pressure oscillations within the combustion chamber in a designated frequency of interest.

In an embodiment, a gas turbine engine combustor is provided that includes a combustion chamber and an outer liner. The combustion chamber has an annular shape defined between an inner liner and the outer liner. A front end of the combustion chamber is defined by a dome plate extending between the inner liner and the outer liner. The dome plate has inlet openings therethrough that are positioned to allow a primary air stream and a main fuel stream into the combustion chamber for a primary combustion reaction of the gas turbine engine. The outer liner includes an igniter cavity formed therein. The igniter cavity is separated from the combustion chamber by a partition wall of the outer liner. The outer liner includes one or more cavity walls that define an injector opening for allowing an auxiliary fuel stream into the igniter cavity. The one or more cavity walls also define cooling holes for allowing a secondary air stream into the igniter cavity for a secondary combustion reaction of the gas turbine engine. The igniter cavity is fluidly connected with the combustion chamber via one or more transfer holes extending through the partition wall. The one or more transfer holes are positioned to direct heat generated by the secondary combustion reaction into the combustion chamber.

Optionally, the igniter cavity is elongated to extend along at least a portion of a circumference of the outer liner.

Optionally, the combustion chamber extends rearward from the front end along a longitudinal axis for a length to a rear end of the combustion chamber. The igniter cavity has a length along the longitudinal axis that is less than one-third of the length of the combustion chamber.

Optionally, the one or more transfer holes of the partition wall are positioned to direct heat generated by the secondary combustion reaction into the combustion chamber near the front end.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are example embodiments. Many other embodiments will be apparent to those of ordinary skill in the art upon reviewing the above description. The scope of the subject matter described herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A gas turbine engine combustor comprising:
a dome plate having a front side and a rear side and defining a central bore therethrough;
an inner liner coupled to the dome plate and extending rearward therefrom; and
an outer liner coupled to the dome plate and extending rearward therefrom, the outer liner surrounding the inner liner and radially spaced apart from the inner liner to define an annular combustion chamber therebetween that extends rearward from the dome plate,
wherein at least one of the outer liner or the dome plate includes an igniter cavity formed therein, the igniter cavity separated from the combustion chamber by a partition wall of the at least one of the outer liner or the dome plate that includes the igniter cavity, the partition wall defining one or more transfer holes therethrough that fluidly connect the igniter cavity to the combustion chamber.

2. The combustor of claim 1, wherein the igniter cavity is in the dome plate between the front side and the rear side outward of the central bore, the partition wall extending along the rear side of the dome plate, the igniter cavity disposed in front of the combustion chamber.

3. The combustor of claim 1, wherein the igniter cavity is in the outer liner between an interior surface of the outer liner and an exterior surface of the outer liner, the igniter cavity disposed radially outward of the combustion chamber and rearward of the dome plate.

4. The combustor of claim 3, wherein the rear side of the dome plate defines a front end of the igniter cavity.

5. The combustor of claim 3, wherein the igniter cavity is spaced apart rearward from the rear side of the dome plate, the outer liner including a front cavity wall that defines a front end of the igniter cavity.

6. The combustor of claim 3, wherein a thickness of the outer liner between the interior surface and the exterior surface is greater at a location of the igniter cavity than at a location rearward of the igniter cavity.

7. The combustor of claim 1, wherein at least one of the outer liner or the dome plate includes an injector opening positioned to allow an auxiliary fuel stream into the igniter cavity and also includes cooling holes for allowing a secondary air stream into the igniter cavity for a secondary combustion reaction of the gas turbine engine, the one or more transfer holes in the partition wall positioned to direct heat generated by the secondary combustion reaction into the combustion chamber.

8. The combustor of claim 7, wherein the heat generated by the secondary combustion reaction that is directed through the one or more transfer holes in the partition wall into the combustion chamber is configured to one or more of sustain or initiate a primary combustion reaction of the gas turbine engine within the combustion chamber.

9. The combustor of claim 1, wherein an interior surface of the partition wall defines a portion of the combustion chamber and an opposite, exterior surface of the partition wall defines a portion of the igniter cavity.

10. The combustor of claim 1, wherein the igniter cavity has an annular shape and extends along an entire circumference of the at least one of the outer liner or the dome plate that includes the igniter cavity.

11. The combustor of claim 1, wherein the igniter cavity is a first cavity that extends along a portion of a circumference of the at least one of the outer liner or the dome plate that includes the igniter cavity, the at least one of the outer liner or the dome plate that includes the igniter cavity further including a second cavity that is isolated from the first cavity and spaced apart from the first cavity along the circumference.

12. The combustor of claim 1, wherein the combustion chamber extends rearward from the dome plate along a longitudinal axis for a length to a rear end of the combustion chamber, the igniter cavity having a length along the longitudinal axis that is less than one-third of the length of the combustion chamber.

13. The combustor of claim 1, further comprising a first fuel injector and a second fuel injector, the first fuel injector extending through an inlet opening in the dome plate and configured to supply a main fuel stream into the combustion chamber for a primary combustion reaction of the gas turbine engine, the second fuel injector extending through an injector opening in the dome plate or the outer liner and configured to supply an auxiliary fuel stream into the igniter cavity for a secondary combustion reaction of the gas turbine engine.

14. The combustor of claim 1, wherein the igniter cavity has a size configured to dampen pressure oscillations within the combustion chamber in a designated frequency of interest.

15. A method comprising
forming an igniter cavity within at least one of an outer liner or a dome plate for a combustor of a gas turbine engine, the igniter cavity defined between a partition wall and one or more cavity walls of the at least one of the outer liner or the dome plate that includes the igniter cavity, the partition wall including one or more transfer holes extending therethrough;
coupling an inner liner to the dome plate such that the inner liner extends rearward from the dome plate; and
coupling the outer liner to the dome plate such that the outer line extends rearward from the dome plate and surrounds the inner liner, the outer liner radially spaced apart from the inner liner to define an annular combustion chamber therebetween that extends rearward from the dome plate, the combustion chamber separated from the igniter cavity by the partition wall and fluidly connected to the igniter cavity through the one or more transfer holes in the partition wall.

16. The method of claim 15, further comprising supplying a main fuel stream via a first fuel injector into the combustion chamber through an inlet opening in the dome plate for a primary combustion reaction of the gas turbine engine, and supplying an auxiliary fuel stream via a second fuel injector into the igniter cavity through an injector opening in the dome plate or the outer liner for a secondary combustion reaction of the gas turbine engine.

17. The method of claim 15, wherein the outer liner extends along a longitudinal axis between a front end and a rear end thereof, the front end of the outer liner coupled to the dome plate, wherein the igniter cavity is formed in the outer liner and located more proximate to the front end than the rear end.

18. The method of claim 15, further comprising sizing the igniter cavity such that the igniter cavity dampens pressure oscillations within the combustion chamber in a designated frequency of interest.

19. A gas turbine engine combustor comprising:
a combustion chamber having an annular shape defined between an inner liner and an outer liner, a front end of the combustion chamber defined by a dome plate extending between the inner liner and the outer liner, the dome plate having inlet openings therethrough that are positioned to allow a primary air stream and a main fuel stream into the combustion chamber for a primary combustion reaction of the gas turbine engine,
wherein the outer liner includes an igniter cavity formed therein, the igniter cavity separated from the combustion chamber by a partition wall of the outer liner, the outer liner including one or more cavity walls that define an injector opening for allowing an auxiliary fuel stream into the igniter cavity, the one or more cavity walls also defining cooling holes for allowing a secondary air stream into the igniter cavity for a secondary combustion reaction of the gas turbine engine,
wherein the igniter cavity is fluidly connected with the combustion chamber via one or more transfer holes extending through the partition wall, the one or more transfer holes positioned to direct heat generated by the secondary combustion reaction into the combustion chamber.

20. The combustor of claim 19, wherein the igniter cavity is elongated to extend along at least a portion of a circumference of the outer liner.

21. The combustor of claim 19, wherein the combustion chamber extends rearward from the front end along a longitudinal axis for a length to a rear end of the combustion chamber, the igniter cavity having a length along the longitudinal axis that is less than one-third of the length of the combustion chamber.

22. The combustor of claim 19, wherein the one or more transfer holes of the partition wall are positioned to direct heat generated by the secondary combustion reaction into the combustion chamber near the front end.
